(19) United States
(12) Patent Application Publication
(10) Pub. No.: US 2012/0246984 A1
(43) Pub. Date: Oct. 4, 2012

(54) THREE DIMENSIONAL (3D) GREETING CARDS WITH 3D GLASSES

(76) Inventor: Sagi Kormandel, Corona Del Mar, CA (US)

(21) Appl. No.: 13/422,562

(22) Filed: Mar. 16, 2012

Related U.S. Application Data
(60) Provisional application No. 61/453,962, filed on Mar. 18, 2011.

(51) Int. Cl. G09F 1/00

(52) U.S. Cl. 40/124.01

(57) ABSTRACT

Greeting cards with integrated 3D glasses.

### RELATED APPLICATION

This application is a non-provisional of and claims priority to U.S. Provisional Patent Application No. 61/453,962, filed, Mar. 18, 2011, entitled THREE DIMENSIONAL (3D) GREETING CARDS WITH 3D GLASSES, to Kormandel, which provisional application is incorporated herein by reference in its entirety.

### BACKGROUND OF THE INVENTION

1. Field of the Invention

The present invention relates to three dimensional (3D) drawings and greeting cards.

2. Discussion of the Related Art

Greeting cards, such as, for example, Birthday cards, Christmas cards, Holiday cards, Condolence cards, Easter cards, Thank You cards, Halloween cards, Get Well cards, Sympathy cards, Think of You cards, Congratulations cards, New Baby cards. Wedding cards, Anniversary cards, Valentines cards, etc. are sold in the millions upon millions every year.

Additionally, three dimensional drawings placed on paper or other material are also known. However, in order to view the 3D drawings in the manner intended, a person needs to wear 3D glasses, for example, glasses having one cyan and one red lens.

### BRIEF DESCRIPTION OF THE DRAWINGS

The features and advantages of the present embodiments will be apparent from the following description, presented in conjunction with the following drawings, wherein:

FIG. 1 is a diagram illustrating a 3D greeting card with integrated 3D glasses in accordance with one embodiment;

FIG. 2 is a diagram illustrating a 3D greeting card with integrated 3D glasses in accordance with another embodiment;

FIG. 3 is a diagram illustrating a 3D greeting card with integrated 3D glasses in accordance with a subsequent embodiment;

FIG. 4 is a diagram illustrating a 3D greeting card with integrated 5 3D glasses in accordance with yet another embodiment;

FIG. 5 is a diagram illustrating a 3D greeting card with integrated 3D glasses in accordance with another embodiment;

FIG. 6 is a diagram illustrating a 3D greeting card with integrated 3D glasses in accordance with yet another subsequent embodiment;

FIG. 7 is a diagram illustrating a 3D greeting card with integrated 3D glasses in accordance with one embodiment;

FIG. 8 is a diagram illustrating a 3D greeting card with integrated 3D glasses in accordance with one embodiment;

FIG. 9 is a diagram illustrating a 3D greeting card with integrated 3D glasses in accordance with another embodiment;

FIG. 10 is a diagram illustrating a 3D greeting card with integrated 3D glasses in accordance with still another embodiment; and

FIG. 11 is a diagram illustrating a 3D greeting card with integrated 3D glasses in accordance with yet another embodiment.

Corresponding reference characters indicate corresponding components throughout the several views of the drawings. Skilled artisans will appreciate that elements in the figures are illustrated for simplicity and clarity and have not necessarily been drawn to scale. For example, the dimensions, sizing, and/or relative placement of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is usually accorded to such terms and expressions by those skilled in the corresponding respective areas of inquiry and study except where other specific meanings have otherwise been set forth herein.

### DETAILED DESCRIPTION OF THE DRAWINGS

The following description is not to be taken in a limiting sense, but is made merely for the purpose of describing the general principles of the invention. The scope of the invention should be determined with reference to claims (whether presented now or in the future). The present embodiments address the problems described in the background while also addressing other additional problems as will be seen from the following detailed description.

With the success and trend of 3D hitting the market, 3D images on greeting cards is a great new compelling way to showcase the average greeting card. This is done by having 3D glasses attached to the card itself. There are a number of problems associated with simply adding glasses to the inside of the card without the glasses being attached or otherwise secured to the card. First, the glasses can be stolen. Second, the glasses can be worn down and torn from people excessively trying out the card before purchasing the card. Third, the glasses can be lost leaving the consumer with a card of a 3D image that cannot be viewed. Finally, for the retailer, they don't have to worry about supplying “sampler glasses” because the embodiments described herein are “an all in one” unit that can be viewed, reviewed, and purchased.

Referring to FIG. 1, a diagram is shown illustrating a 3D greeting card with integrated 3D glasses in accordance with one embodiment. Shown is a greeting card with a first surface 100 coupled to a second surface 102 through a folded edge. A pair of 3D glasses 104 is attached to the second surface 102 through a perforated edge. A 3D drawing can be placed on any surface of the 3D greeting card. For example, a 3D drawing can be placed on the front of the card (not shown), back of the card (not shown), the first surface 100 and/or the second surface 102. When closed (not shown), the 3D glasses 104 can be folded up in between the first surface 100 and the second surface 102.

In operation, a recipient of the card can remove the 3D glasses 104 from the greeting card by tearing the perforated edge. Advantageously, the recipient or other person can view the 3D drawing(s) that are included on the greeting card without having to purchase or otherwise obtain 3D glasses.

The 3D glasses shown in FIG. 1 include one red and one cyan colored lens. Moreover, the other embodiments described herein will he described with reference to cyan and red colored lenses in 3D drawings. However, other color schemes may also be utilized in other embodiments and are within the scope of the currently contemplated embodiments. For example, red and blue lenses are utilized in one embodiment. Other embodiments include various possible combinations of colors for anaglyphs, including, for example, red-green, red-blue, greenblue, green-magenta (red+blue), or blue-yellow (red+green). Corresponding colors are used in the 3D drawings according to the color of the lenses of the glasses. Any colors that allow for creating and viewing 3D images can be utilized in various embodiments.

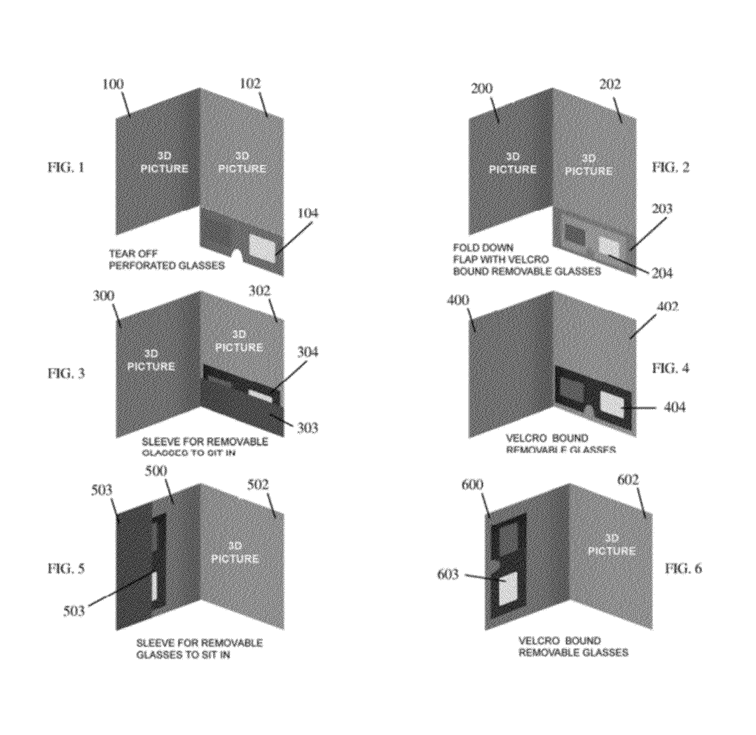

Referring to FIG. 2 a diagram is shown illustrating a 3D greeting card with integrated 3D glasses in accordance with another embodiment. Shown is a greeting card with a first surface 200 coupled to a second surface 202 through a folded edge. A third surface 203 is coupled to the second surface 202 through another folded edge. A pair of 3D glasses 204 is attached to the third surface 203 by a Velcro strip. A 3D drawing can be placed on any surface of the 3D greeting card. For example, a 3D drawing can be placed on the front of the card (not shown), back of the card (not shown), the first surface 200 and/or the second surface 202. When closed (not shown), the 3D glasses 204 can be folded up in between the first surface 200 and the second surface 202.

In operation, a recipient of the card can remove the 3D glasses from the greeting card by pulling it from the Velcro strip. Advantageously, the recipient or other person can view the 3D drawing(s) that are included on the greeting card without having to purchase or otherwise obtain 3D glasses.

Referring to FIG. 3 a diagram is shown illustrating a 3D greeting card with integrated 3D glasses in accordance with a subsequent embodiment. Shown is a greeting card with a first surface 300 coupled to a second surface 302 through a folded edge. A third surface 303 is coupled to the bottom-front side of the second surface 202 and forms a sleeve. A pair of 3D glasses 204 is placed into the sleeve of the greeting card in between the second surface 302 and the third surface 303. A 3D drawing can be placed on any surface of the 3D greeting card. For example, a 3D drawing can be placed on the front of the card (not shown), back of the card (not shown), the first surface 300, the second surface 302 and/or the third surface.

In operation, a recipient of the card can remove the 3D glasses 304 from the greeting card by pulling it out of the sleeve between the second surface 302 and the third surface 303. Advantageously, the recipient or other person can view the 3D drawing(s) that are included with the greeting card without having to purchase or otherwise obtain 3D glasses.

Referring to FIG. 4 a diagram is shown illustrating a 3D greeting card with integrated 3D glasses in accordance with yet another embodiment. Shown is a greeting card with a first surface 400 coupled to a second surface 402 through a folded edge. A pair of 3D glasses 404 is attached to the second surface 402 by a Velcro strip. A 3D drawing can be placed on any surface of the 3D greeting card. For example, a 3D drawing can he placed on the front of the card (not shown), back of the card (not shown), the first surface 400 and/or the second surface 402.

In operation, a recipient of the card can remove the 3D glasses from the greeting card by pulling it from the Velcro strip. Advantageously, the recipient or other person can view the 3D drawing(s) that are included on the greeting card without having to purchase or otherwise obtain 3D glasses.

Referring to FIG. 5 a diagram is shown illustrating a 3D greeting card with integrated 3D glasses in accordance with another embodiment. Shown is a greeting card with a first surface 500 coupled to a second surface 502 through a folded edge. A third surface 503 is coupled to the left-front side of the first surface 500 and forms a sleeve. A pair of 3D glasses 504 is placed into the sleeve of the greeting card in between the first surface 500 and the third surface 503. A 3D drawing can be placed on any surface of the 3D greeting card. For example, a 3D drawing can he placed on the front of the card (not shown), back of the card (not shown), the first surface 500, the second surface 502 and/or the third surface 503.

In operation, a recipient of the card can remove the 3D glasses 504 from the greeting card by pulling it out of the sleeve between the first surface 500 and the third surface 503. Advantageously, the recipient or other person can view the 3D drawing(s) that are included with the greeting card without having to purchase or otherwise obtain 3D glasses.

Referring to FIG. 6, a diagram is shown illustrating a 3D greeting card with integrated 3D glasses in accordance with yet another subsequent embodiment. Shown is a greeting card with a first surface 600 coupled to a second surface 602 through a folded edge. A pair of 3D glasses 604 is attached to the first surface 600 by a Velcro strip. A 3D drawing can be placed on any surface of the 3D greeting card. For example, a 3D drawing can be placed on the front of the card (not shown), back of the card (not shown), the first surface 600 and/or the second surface 602.

In operation, a recipient of the card can remove the 3D glasses 604 from the greeting card by pulling it from the Velcro strip. Advantageously, the recipient or other person can view the 3D drawing(s) that are included on the greeting card without having to purchase or otherwise obtain 3D glasses.

Referring to FIG. 7, a diagram is shown illustrating a 3D greeting card with integrated 3D glasses in accordance with one embodiment. Shown is a greeting card with a first surface 700 coupled to a second surface 702 through a folded edge. A pair of 3D glasses 704 is attached to a side of the second surface 702 through a perforated edge. A 3D drawing can be placed on any surface of the 3D greeting card. For example, a 3D drawing can be placed on the front of the card (not shown), back of the card (not shown), the first surface 700 and/or the second surface 702. When closed (not shown), the 3D glasses 704 are optionally folded up in between the first surface 700 and the second surface 702.

In operation, a recipient of the card can remove the 3D glasses 704 from the greeting card by tearing the perforated edge. Advantageously, the recipient or other person can view the 3D drawing(s) that are included on the greeting card without having to purchase or otherwise obtain 3D glasses.

Referring to FIG. 8, a diagram is shown illustrating a 3D greeting card with integrated 3D glasses in accordance with one embodiment. Shown is a greeting card with a first surface 800 coupled to a second surface 802 through a folded edge. A pair of 3D glasses 804 is integrated into a third surface 803 that is coupled to the second surface 802 through a folded edge. Preferably, a 3D drawing is placed upon the first surface such that it can easily be viewed through the 3D glasses 804 when the card is unfolded such as shown in FIG. 8. Alternatively, a 3D drawing can be placed on the front of the card (not shown), back of the card (not shown), the first surface 800 and/or the second surface 802. When closed (not shown), the 3D glasses 804 can be folded up in between the first surface 800 and the second surface 802.

Advantageously, the recipient or other person can view the 3D drawing(s) that are included on the greeting card without having to purchase or otherwise obtain 3D glasses.

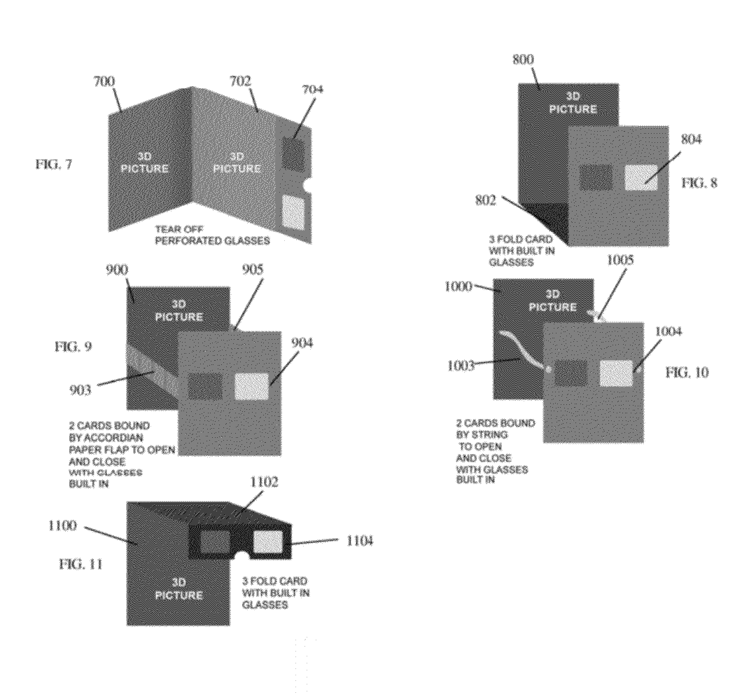

Referring to FIG. 9 a diagram is shown illustrating a 3D greeting card with integrated 3D glasses in accordance with another embodiment. Shown is a greeting card with a first surface 900 coupled to a second surface 902 by a first accordion connector 903 and a second accordion connector 905. A pair of 3D glasses 904 is integrated into the second surface 902. Preferably, a 3D drawing is placed upon the first surface such that it can easily be viewed through the 3D glasses 904 when the card is unfolded such as shown in FIG. 9. When closed (not shown), the first accordion connector 903 and the second accordion connector 905 are retracted so that the first surface 900 is adjacent to the second surface 902.

In operation, a recipient of the card can pull the first surface 900 away from the second surface 902 and then view the 3D image on the first surface 900 through the 3D glasses 904. Advantageously, the recipient or other person can view the 3D drawing(s) that are included on the greeting card without having to purchase or otherwise obtain 3D glasses.

Referring to FIG. 10, a diagram is shown illustrating a 3D greeting card with integrated 3D glasses in accordance with still another embodiment. Shown is a greeting card with a first surface 1000 coupled to a second surface 1002 by a first string 903 and a second string 905. A pair of 3D glasses 1004 is integrated into the second surface 1002. Preferably, a 3D drawing is placed upon the first surface 1000 such that it can easily be viewed through the 3D glasses 1004 when the card is unfolded such as shown in FIG. 10. When closed (not shown), the first string 1003 and the second string 1005 allow the first surface 1000 to be adjacent to the second surface 1002.

In operation, a recipient of the card can pull the first surface 1000 away from the second surface 1002 and then view the 3D image on the first surface 1000 through the 3D glasses 1004. Advantageously, the recipient or other person can view the 3D drawing(s) that are included on the greeting card without having to purchase or otherwise obtain 3D glasses.

Referring to FIG. 11, a diagram is shown illustrating a 3D greeting card with integrated 3D glasses in accordance with yet another embodiment. Shown is a greeting card with a first surface 1100 coupled to a second surface 1102 through a folded edge. A pair of 3D glasses 1104 is integrated into a third surface 1103 that is coupled to the second surface 1102 through a folded edge. Preferably, a 3D drawing is placed upon the first surface 1100 such that it can easily be viewed through the 3D glasses 1104 when the card is unfolded such as shown in FIG. 8. Alternatively, a 3D drawing can be placed on the front of the card (not shown), back of the card (not shown), the first surface 1100 and/or the second surface 1102. When closed (not shown), the 3D glasses 1104 can be folded up in between the first surface 1100 and the second surface 1102.

Advantageously, the recipient or other person can view the 3D drawing(s) that are included on the greeting card without having to purchase or otherwise obtain 3D glasses.

As referred to throughout, the 3D glasses described herein generally include a first colored lens, a second colored lens and a frame holding the lenses together. The frame can optionally include portions (not shown herein) that fit over a person's ears, although not required. In some embodiments, such as shown in FIGS. 1 and 7-11, glasses (i.e., the frame and lenses) form a portion of the greeting card and are thus, integrated therewith. In other embodiments, such as shown in FIGS. 2-6, the glasses are integrated into the greeting card by being placed into a sleeve or attached via Velcro.

While the invention herein disclosed has been described by means of specific embodiments and applications thereof, other modifications, variations, and arrangements of the present invention may be made in accordance with the above teachings other than as specifically described to practice the invention.

I claim:

1. A greeting card comprising:
a body of the greeting card;
a first lens, having a first color, integrated into the body of the greeting card; and
a second lens, having a second color that is different from the first color, integrated into the body of the card adjacent to the first lens;
wherein the first lens and second lens are utilized to view 3D content on the body of the greeting card.

2. The greeting card of claim 1 wherein the first color of the first lens is red and the second color for the second lens is cyan.

3. The greeting card of claim 1 wherein the first color of the first lens and the second color of the second lens are selected from one of the following color combinations: red-cyan, red-green, red-blue, green-blue, green-magenta, and blue-yellow.

4. The greeting card of claim 1, wherein the greeting card is one of a Birthday card, Christmas card, Holiday card, Condolence card, Easter card, Thank You card, Halloween card, Get Well card, Sympathy card, Think of You card, Congratulations card, New Baby card, Wedding card, Anniversary card, and Valentines card.

5. The greeting card of claim 1, wherein the first lens and the second lens are not detachable from the body of the greeting card.

6. The greeting card of claim 1, wherein the first lens and the second lens are detachable from the body of the greeting card.

7. The greeting card of claim 1, wherein the first lens and the second lens are attached to the body of the greeting card through a perforated edge.
